(19) United States
(12) Patent Application Publication
(10) Pub. No.: US 2019/0367114 A1
(43) Pub. Date: Dec. 5, 2019

(54) HEIGHT ADJUSTABLE SEAT POST

(71) Applicant: Crank Brothers, Inc., Laguna Beach, CA (US)

(72) Inventors: Carl Winefordner, Laguna Beach, CA (US); Frank Hermansen, Laguna Beach, CA (US)

(21) Appl. No.: 15/994,202

(22) Filed: May 31, 2018

(51) Int. Cl. B62J 1/08

(52) U.S. Cl. CPC B62J 1/08; B62J 2001/085

(57) ABSTRACT

A height adjustable seat post, including a body and a quill. Quill is slideably associated to body to be selectively translated between an upper locked position and a lower locked position. Quill includes a spring, and a plurality of lock elements, slideably engaged in a respective plurality of through seats, distributed along quill cross section; the spring is suitable to spring load the lock elements radially outward so as to protrude from the respective through seats. The body of the seat post includes a plurality of first through slots, a plurality of partial upper slots and a plurality of partial lower slot. The lock elements are selectively engageable in the partial upper slots so as to retain quill in the upper locked position, or in the partial lower slots so as to retain quill in the lower locked position, or in the first through slots, along which they can slide.

### FIELD OF THE INVENTION

The present invention relates to a height adjustable seat post.

### BACKGROUND OF THE INVENTION

Height adjustable seat posts have become commonplace on mountain bikes, and they are beginning to be used on other categories of bicycles such as road bikes, commuter bikes, e-bikes and cyclocross bikes.

On mountain bikes, the biggest advantage of using height adjustable seat posts is that descending steep terrains is safer and easier by lowering the saddle height.

However, many other advantages can be achieved by using an adjustable height seat post on any kind of bicycle.

For example, by lowering the saddle just before stopping, the rider's feet can reach the ground while being seated: this makes the stop more comfortable, as well as easier to start riding again.

Furthermore, when descending at high speeds on any surface, it is more stable and safer to be seated at a lower position; this applies, for example, to road bikes traveling fast down a mountain pass on pavement.

Also, lowering the saddle lowers the rider's center of gravity which allows faster braking without the bicycle flipping over forwards.

In addition, when riding for long periods of time, it feels good to occasionally change riding positions by lowering and rising the saddle, thus relieving pressure on certain body parts.

However, up to now height adjustable seat posts are also affected by many drawbacks, which are briefly listed below.

Today, height adjustable seat posts are rather heavy, they weigh about 660 grams including cable, cable housing and remote control; a fixed seat post typically weighs between about 200 and 350 grams.

Height adjustable seat posts are rather complex to install and remove, therefore they require frequent maintenance.

Installation typically requires running a cable and a cable housing through the bicycle frame, mounting the remote control, attaching the cable, and adjusting the cable pull.

It is even more difficult for seat posts that are hydraulically actuated instead of cable actuated, because hydraulically actuated hoses may require bleeding the system to eliminate air bubbles.

Complexity lead to high cost: current height adjustable seat posts cost more than the average complete bicycle.

Oftentimes, an adjustable height seat post cannot be made in smaller diameters such as 27.2 mm (typical size for road bikes) because, due to its complexity, the system cannot be made this small while still passing international safety standards.

In addition, the above cited complexity to install and remove an adjustable height seat post makes it very difficult to move the seat post from bike to bike.

Most height adjustable seat posts use hydraulics to lock the post at different heights, and they require frequent rebuilds or cartridge replacement in order to keep functioning properly; more in general, all adjustable seat posts are relatively unreliable and prone to failing.

Bicycles typically have a lot of controls on the handlebars, already including shifters and brakes; some also include a shock absorber damping control. Cable and lines require maintenance, look messy, and can get caught on things: the control of a height adjustable seat post further worsens the situation.

In order to reduce the number of cables and/or hydraulic lines, “wireless” height adjustable seat posts have been recently developed.

However, such “wireless” seat posts have several disadvantages, mainly because they are heavier, more expensive, they require frequent battery charges, and most important, they are slow reacting: in fact, when the remote control is activated, there is a significant time lag between the button push and when the seat post actuates.

Another type of height adjustment is accomplished via twisting the saddle to unlock and lock the saddle position, particularly by engaging/disengaging a pin, integral with the quill, in/from a profiled slot provided in the body of the seat post. In this way, the saddle can be raised and lowered without the use of hands and without cables or electronics.

There are some drawbacks to the previously described twisting height adjustable seat post. For example, the post has a noticeable amount of vertical play (slop) in both the up and down locked positions.

Also, in order to raise the saddle from the lower to the upper position, the rider must first sit down on the saddle to disengage the pin from the slot.

### OBJECTS OF THE INVENTION

The technical aim of the present invention is therefore to improve the state of the art in the field of adjustable height seat posts.

Within such technical aim, it is an object of the invention to develop an adjustable height seat post which allows to obviate the drawbacks previously complained.

Another object of the present invention is to devise an adjustable height seat post which is constructively simple and inexpensive.

A further object of the present invention is to develop an adjustable height seat post which is reliable and free from malfunctions or failures.

Still another object of the present invention is to devise an adjustable height seat post which is lighter compared to those currently on the market.

Another object of the present invention is to develop an adjustable height seat post with fast activation.

A further object of the present invention is to develop an adjustable height seat post which is easier to install and remove compared to those currently on the market, and easier to move from bike to bike.

Still another object of the present invention is to devise and adjustable height seat post free from cables, lines or remote controls.

Another object of the present invention is to develop an adjustable height seat post which requires little maintenance.

A further object of the present invention is to devise an adjustable height seat post which can be made in smaller diameters to fit road bikes, while still meeting safety standards.

A further object of the present invention is to devise an adjustable height seat post which has an adjustable twisting resistance.

A further object of the present invention is to develop an adjustable height seat post with virtually no up and down play when in a locked position.

### SUMMARY OF THE INVENTION

This aim and these objects are all achieved by an adjustable height seat post comprising a body, suitable to be inserted into a seat tube of a bicycle frame, and a quill, comprising a head assembly provided with clamping means suitable to attach to a bicycle saddle.

Quill is slideably associated to body to be selectively translated between at least an upper locked position and a lower locked position, respectively corresponding to at least an upper height position and a lower height position of the saddle.

Quill includes at least a spring, inserted into its inner cavity, and a plurality of lock elements, slideably engaged in a respective plurality of through seats distributed along quill cross section.

Such spring is suitable to spring load the lock elements radially outward, so as to protrude from the respective through seats.

The body of the seat post comprises, on its inner surface, a plurality of first through slots, a plurality of partial upper slots, and a plurality of partial lower slots, distributed along body cross section.

First through slots, partial upper slots and partial lower slots are in the same number of the lock elements.

Lock elements are selectively engageable, by rotation of quill within body, performed by the rider, in partial upper slots, so as to retain quill in the upper locked position, or in partial lower slots, so as to retain quill in the lower locked position, or in first through slots, along which they can slide, so as to allow the rider to translate the quill between the upper height position and the lower height position of the saddle.

Spring is made of an elastomer or any other suitable material, or it is made from a spring steel continuous or non-continuous band; spring is ring shaped, or substantially ring shaped, and it has an outer surface contacting the inner surface of the lock elements.

Seat post further includes a spring cartridge, inserted in said body, passing through the quill and connected to the head assembly; spring cartridge constantly acts on the head assembly, to push the quill out of the body housing.

The seat post further includes a spacer, having a base which abuts on a shoulder provided in the inner surface of said body; each of the lock elements include a respective first side surface which contacts such base as quill is in the upper locked position, preventing upward movement of quill relative to body. Furthermore, partial upper slots have respective bottom surfaces onto which the lock elements abut as quill is in the upper locked position, and downward movement of quill relative to body is prevented.

As well, partial upper slots have respective top surfaces onto which the lock elements abut as the quill is in the lower locked position, and upward movement of quill relative to body is prevented; in addition, when the quill is in the lower locked position, downward movement is prevented since quill lower base surface abuts on and end cap associated to the bottom of the body.

Therefore, when quill is in the upper locked position or in the lower locked position, it has virtually no upward or downward play, or anyway a very small play that is certainly not perceived by the rider.

The solution according to the invention allows the rider to move the saddle by simply twisting the quill, within the supporting body, in a certain direction, without the need to use hands, and without the need to move the quill upward or downward before twisting, to reach the unlocked position.

This means that using the seat post according to the invention, i.e. to move quill between the upper or lower position of saddle, is much simpler and more immediate for the rider.

It is also highlighted that the twist action on quill by the rider requires that a certain force is applied, and this prevents the quill from being accidentally unlocked.

The force to be applied is that required to deform the spring so that the lock elements can slide inwards within the respective through seats, so they can pass from the upper or lower slots to the first through slots, and vice versa.

The force required to deform the spring can be adjusted by simply replacing the latter with one having different features, or by adding more springs, etc.

### BRIEF DESCRIPTION OF THE DRAWINGS

These and other advantages will be better understood by any man skilled in the art from the following description that follows and from the attached drawings, given as a non-limiting example, in which:

FIG. 1 is a perspective view of the adjustable height seat post with quill in in the upper position, according to the invention;

FIG. 2 is an exploded view of the seat post, according to the invention;

FIG. 3 is a rear view of the seat post;

FIG. 4 is a section view of the seat post, taken on plane IV-IV of FIG. 3;

FIG. 5 is a section view of the seat post, taken along plane V-V of FIG. 3, when quill is in a locked upper position;

FIG. 6 is a section view of the seat post, taken along plane V-V of FIG. 3, with the quill twisted about half way between a locked and unlocked position;

FIG. 7 is a section view of the seat post taken along plane V-V of FIG. 3, with quill about half way between upper and lower height;

FIG. 8 is a section view of the seat post, taken along plane VIII-VIII of FIG. 3, when quill is in a locked lower position;

FIG. 9 is a front view of the seat post with quill in an upper locked position;

FIG. 10 is a front view of the seat post with quill in an upper unlocked position;

FIG. 11 is a front view of the seat post with quill in a lower unlocked position;

FIG. 12 is a front view of the seat post with quill in a lower locked position;

FIG. 13 is a side view of the body of the seat post;

FIG. 14 is an end view of the body;

FIG. 15 is a section view of the body, taken along plane XV-XV of FIG. 14;

FIG. 16 is a section view of the body taken along plane XVI-XVI of FIG. 13;

FIG. 17 is a section view of the body taken along plane XVII-XVII of FIG. 13;

FIG. 18 is a section view of the body taken along plane XVIII-XVIII of FIG. 13;

FIG. 19 is a perspective view of the seat post with quill in the upper locked position;

FIG. 20 is a section perspective view of the seat post;

FIG. 21 is a close-up section perspective view of the seat post;

FIG. 22 is a perspective view of the seat post with quill in the lower locked position;

FIG. 23 is a section perspective view of the seat post with quill in the lower locked position; and

FIG. 24 is a close-up section view of the lower end of the seat post.

### DETAILED DESCRIPTION OF THE INVENTION

With reference to FIG. 1, an adjustable height seat post according to the invention is wholly indicated with 10.

Seat post includes a body 30; body 30 has tubular, or substantially tubular, shape, and it defines a tubular housing.

Body 30 is suitable to be inserted into a seat tube of a bicycle frame (not shown in the drawings).

Body 30 provides structure to the seat post 10: in other words, it provides the necessary resistance and stability features for a correct and reliable use.

Body 30 is closed, by its lower end (when in use position), by and end cap 20.

End cap 20 has a threaded collar 21 suitable to engage a respective threaded portion 37 provided in the lower end of body 30.

End cap 20 includes an inner base surface 22; threaded collar 21 has a top surface 24

Seat post 10 further includes a quill 120; quill 120 is inserted within the tubular housing of body 30.

As better disclosed below, quill 120 can slide, within body 30, from an upper locked position to a lower locked position, at user's discretion, and with reference to the assembled configuration of the seat post 10.

Upper locked position of quill 120 corresponds to the upper height saddle position, while lower locked position corresponds to the lower height saddle position.

Quill 120 can be adjusted from upper locked position to lower locked position without the use of hands.

A head assembly 130 is connected to the free end of quill 120.

Head assembly 130 is of the type known in the art for adjustably clamping a common saddle 140 (shown for example in FIGS. 9-12).

A portion of head assembly 130 is permanently joined to quill 120 with a press fit, bonding, integrally combined, or other suitable method.

Head assembly 130 comprises a base portion 132 fixed to the quill 120, and clamping means 134 suitable to engage saddle 140 (for example, to engage the rails of saddle 140, or other portions of saddle 140).

Clamping means 134 may be such as to allow saddle 140 tilt adjustment.

Clamping means 134 include, for example, a lower cradle 134a and an upper cradle 134b, reciprocally connected to engage saddle 140 rails from opposite sides.

Lower cradle 134a and upper cradle 134b are reciprocally connected by means of screws, curve washers and barrel nuts, assembled in the way shown, for example, in FIG. 4.

More in general, clamping means 134 can be of any kind and design suitable to securely connect the saddle 140 to quill 120.

Body 30 and quill 120 are made of aluminium, or other suitable material.

Quill 120 has tubular shape or substantially tubular shape, and it has a lower base surface 126.

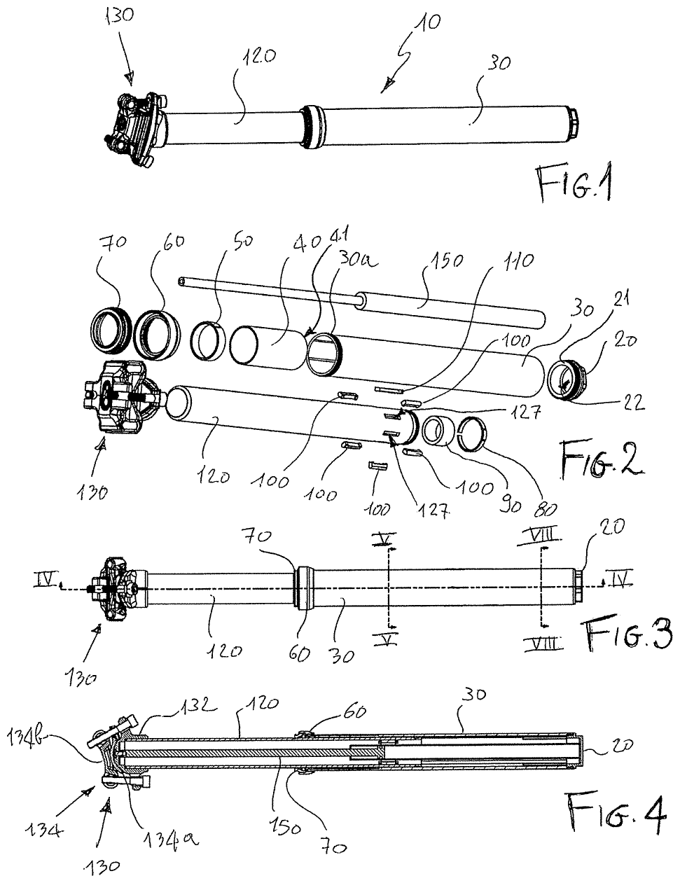

Referring now to FIG. 2, seat post 10 further includes a spring cartridge 150, which is inserted in body 30 housing, passing through quill 120 and connected to head assembly 130.

Spring cartridge 150 is connected to head assembly 130 by means of a screw 152 (see for example FIG. 23).

Spring cartridge 150 constantly acts on head assembly 130, in order to push quill 120 out of body 30 housing.

In an embodiment of the invention of particular practical interest, spring cartridge 150 is a gas pressurized piston with damping; for example, spring cartridge 150 is a gas pressurized piston with damping like the one used on hatch backs on many automobiles.

Spring cartridge 150 is shown in a simplistic form in the figures, for greater clarity, because its features are known in the prior art.

Spring cartridge 150 could also be a simple compression coil spring or any other suitable compression spring that is strong enough to extend seat post 10 (i.e. to push quill 120 with saddle 140) from a lowered position to an upper position.

Body 30 has a threaded end 30a, which is opposite to end cap 20.

A spacer 40 and a bushing 50 are inserted in the body 30 housing; spacer 40 has a base 41 which abuts on a shoulder 40a a provided in the inner surface of body 30 (FIG. 21), and bushing 50 abuts, on turn, on spacer 40.

Bushing 50 is made of a low friction and wear resistant material, such as Delrin or other similar materials.

A threaded ring 60 is engaged in the threaded end 30a of body 30; a seal 70 is engaged in a respective housing provided in threaded ring 60.

Threaded ring 60 holds bushing 50 and spacer 40 within body 30.

Another bushing 80 is engaged in a respective annular seat 82 provided in quill 120.

Annular seat 82 is provided by the end of quill 120 which is opposite to head assembly 130.

Bushing 80 is also made of a low friction and wear resistant material, such as Delrin or other similar materials.

According to an aspect of the invention, quill 120 includes a spring 90.

Spring 90 is inserted into quill 120 inner cavity.

Quill 120 further includes at least a lock element 100, slideably engaged in a respective through seat 127 provided in quill 120.

More in detail, spring 90 is suitable to spring load, or push, lock element 100 radially outward, sliding inside the respective through seat 127; as lock element 100 is pushed outward by spring 90, it protrudes from the same through seat 127, and it protrudes from the outer surface of quill 120.

The at least one through seat 127 is provided in quill 120 by the end which is opposite to head assembly 130.

In the embodiment of the invention shown in the figures, which is preferred but not exclusive, quill 120 includes a plurality of lock elements 100, slideably engaged in a respective plurality of through seats 127.

Through seats 127 are distributed along quill 120 tubular section—and therefore along a circumference—possibly uniformly, or substantially uniformly.

For example, in the embodiment shown in the figures, lock elements 100, and respective through seats 127, are in number of five.

Lock elements 100, and respective through seats 127, could be in any number.

Spring 90 is ring shaped, or substantially ring shaped, and it is made, for example, of an elastomer such as 90A shore polyurethane, or any other suitable material.

In some embodiments of the invention, spring 90 could be made from a thin spring steel continuous or non-continuous band.

Each of lock elements 100—when observed in cross section, see for example FIG. 5—has a planar, or substantially planar, inner surface, and a rounded, or substantially rounded, outer surface.

As shown, for example, in FIG. 5, the outer surface of spring 90 contacts the inner surfaces of all lock elements 100.

More in detail—as shown in FIG. 21 or 24—each of lock elements 100 includes, by its inner surface, a respective recess 104 suitable for housing the outer portion of spring 90, to prevent the parts accidentally moving from one another.

As shown in FIG. 24, each of through seats 127 has a respective upper surface 121 and a respective lower surface 122.

Alike, each of lock elements 100 has a respective first side surface 101 and a second side surface 102 (FIG. 21).

For example, first side surface 101 of any lock element 100 contacts upper surface 121 of the respective through seat 127, while second side surface 102 of the same lock element 100 contacts lower surface 122 of the respective through seat 127.

Each of lock elements 100 can slide radially relative to quill 120, but it cannot move longitudinally relative to quill 120: therefore, when lock elements 100 are prevented from moving longitudinally relative to body 30, quill 120 is also prevented from moving longitudinally.

According to an aspect of the invention, quill 120 includes at least a key 110, which fits into a key slot 123 provided in its outer surface.

Key slot 123 includes a first terminal surface 124 and a second terminal surface 125, opposed to each other (FIG. 24).

As better clarified later, key 110 limits rotation between quill 10 and body 30.

Key 110 as an upper end surface 111, and a lower end surface 112.

Upper end surface 111 contacts first terminal surface 124, and lower end surface 112 contacts second terminal surface 125 of key slot 123.

As previously stated, quill 120 slideably fits within body 30.

According to another aspect of the invention, the inner surface of body 30 comprises at least a first through slot 31.

First through slot 31 is open at the two ends of body 30.

The at least one lock element 100 of quill 120 can slide longitudinally along the first through slot 31.

More preferably, the inner surface of body 30 comprises a plurality of first through slots 31.

First through slots 31 are distributed along body 30 tubular section, and they are in the same number of lock elements 100, and they are distributed, within the inner surface of body 30, at the same angular distances provided for between the lock elements 100 in quill 120.

Therefore, the plurality of lock elements 100 of quill 120 can slide longitudinally along the respective first through slots 31 of body 30.

First through slots 31 (see for example FIGS. 5-8, or FIG. 17) have rounded, or substantially rounded, cross section.

Cross section of first through slots 31 is complementary to the cross section of lock elements 100.

The inner surface of body 30 further includes a second through slot 32.

Second through slot 32 is open at the two ends of body 30.

Second through slot 32 have larger cross section than first through slots 31.

Second through slot 32 is interposed between two adjacent first through slots 31, in such a way that first through slots 31 and second through slot 32 are arranged according to the vertices of a hexagon (preferably, but not exclusively, a regular hexagon).

Second through slot 32 have rectangular, or substantially rectangular, cross section.

Key 110 of quill 120 is engaged in second through slot 32, and it can longitudinally slide along second through slot 32.

When observed in cross section, second through slot 32 is larger than key 110: consequently, quill 120 can also rotate, within body 30, a limited amount (determined by the width of second through slot 32 with respect to the width of key 110).

Body 30 can be made, for example, from an aluminium extrusion, such that first through slots 31 and second through slot 32 do not require machining.

According to another aspect of the invention, body 30 includes, in its inner surface, at least a partial lower slot 33.

Referring to FIG. 16, in a preferred embodiment of the invention, body 30 includes, in its inner surface, a plurality of partial lower slots 33 (which are in the same number of lock elements 100).

FIG. 16 represents the cross section of body 30 taken along plane XVI-XVI of FIG. 13, and it shows partial lower slots 33 and first through slots 31.

FIG. 17 represents the cross section of body 30 taken along plane XVII-XVII of FIG. 13, and it shows just the first through slots 31, and second through slot 32.

Partial lower slots 33 only extend partway through body 30; partial lower slots 33 are open by the lower end of body 30.

Partial lower slots 33 are in the same number of lock elements 100, and they are distributed, within the inner surface of body 30, at the same angular distances provided for between the lock elements 100 in quill 120.

In other words, when body 30 is observed in section, partial lower slots 33 are offset, by a certain angle, relative to first through slots 31.

Partial lower slots 33 have rounded, or substantially rounded, cross section; cross section of partial lower slots 33 is complementary to the cross section of lock elements 100.

Furthermore, body 30 includes, in its inner surface, at least a partial upper slot 34.

Referring to FIG. 18, in a preferred embodiment of the invention, body 30 includes, in its inner surface, a plurality of partial upper slots 34 (which are in the same number of lock elements 100).

FIG. 18 represents the cross section of body 30 taken along plane XVIII-XVIII of FIG. 13, and it shows partial upper slots 34 and first through slots 31. Partial upper slots 34 only extend partway through body 30; partial upper slots 34 are open by the upper end of body 30.

Partial upper slots 34 are in the same number of lock elements 100, and they are distributed, within the inner surface of body 30, at the same angular distances provided for between the lock elements 100 in quill 120.

In other words, when body 30 is observed in section, partial upper slots 34 are offset, by a certain angle, relative to first through slots 31.

Partial upper slots 34 have rounded, or substantially rounded, cross section; cross section of partial upper slots 34 is complementary to the cross section of lock elements 100.

Partial upper slots 34 are offset, relative to first through slots 31, in the same direction in which partial lower slots 33 are offset.

This means that—as it can be seen in FIGS. 16,18—partial lower slots 33 and partial upper slots 34 are respectively aligned with respect to the cylindrical symmetry axis of body 30.

In other words, when body 30 is observed in cross section, partial upper slots 34 are superimposed to partial lower slots 33.

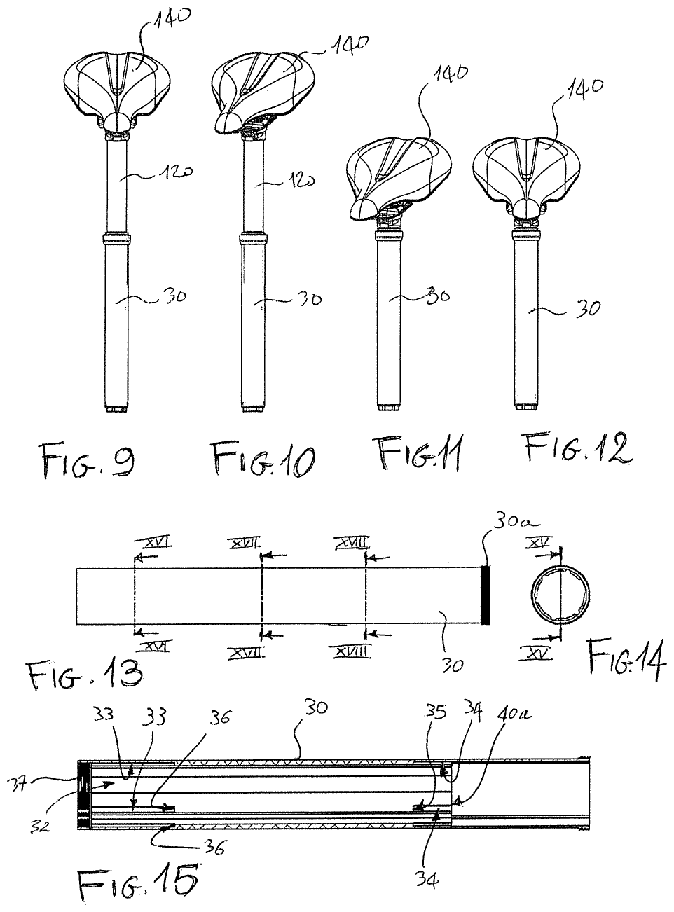

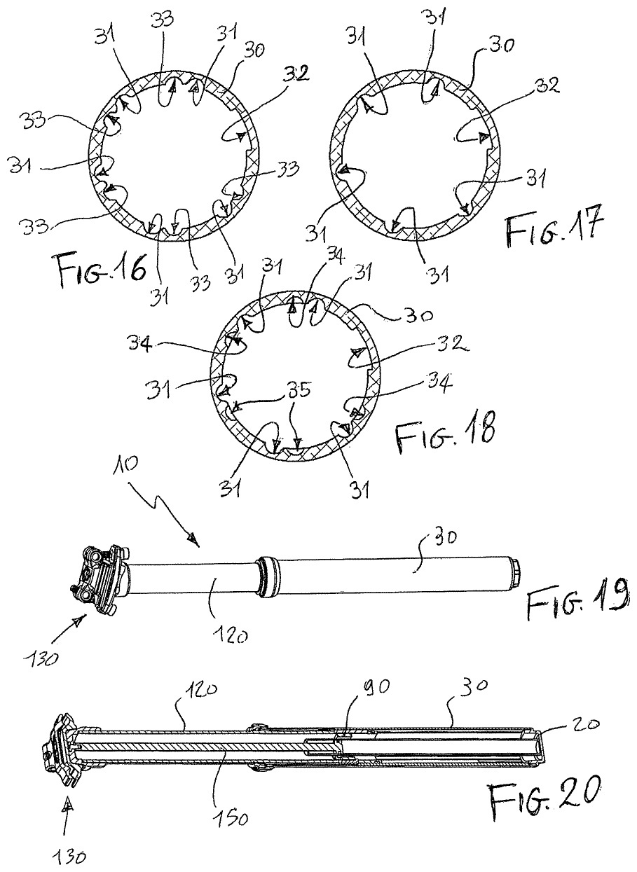

As shown, for example, in FIG. 15, partial lower slots 33 have respective top surfaces 36; partial upper slots 34 have respective bottom surfaces 35.

Lock elements 100 abut on respective top surfaces 36 as quill 120 is in the lower locked position, and upward movement of quill 120 relative to body 30 is prevented.

As well, lock elements 100 abut on respective bottom surfaces 35 as quill 120 is in the upper locked position, and downward movement of quill 120 relative to body 30 is prevented.

Partial upper slots 34 and partial lower slots 33 have the same cross section, or substantially the same cross section; in turn, partial upper slots 34 and partial lower slots 33 have the same cross section of first through slots 31.

The inner surface of body 30 comprises, at the portions included between first through slots 31 and partial upper slots 34, and between first through slots 31 and partial lower slots 33, filleted areas which are suitable to facilitate the passage of lock elements 100 between different slots 31,33,34, as the quill 120 rotates within body 30, as better disclosed hereafter.

Partial upper slots 34 and partial lower slots 33 are made by broaching, machining, or other suitable method.

As shown in FIG. 5, spring 90 spring loads lock elements 100 radially outward, and lock elements 100 are engaged (tightly fit) in their respective partial upper slots 34; in this configuration, quill 120 is in its upper locked position.

Key 110, engaged in second through slot 32, prevents quill 120 from twisting too far: in other words, the engagement of key 110 in second through slot 32 (and in particular, the width of the second through slot 32) restricts the rotation of quill 120 within body 30 between two limit angular positions.

In the upper locked position of quill 120, lock elements 100, engaged in respective partial upper slots 34, prevent longitudinal movement of quill 120 within body 30, and also prevent rotational movement of quill 120 unless enough twisting force is applied to distort spring 90 inwards; in other words, rotational play between quill 120 and body 30 is removed.

In this position, key 110 is against one side of second through slot 32.

A purposeful twisting force applied on saddle 140 is required to rotate the quill 120 from the upper locked position.

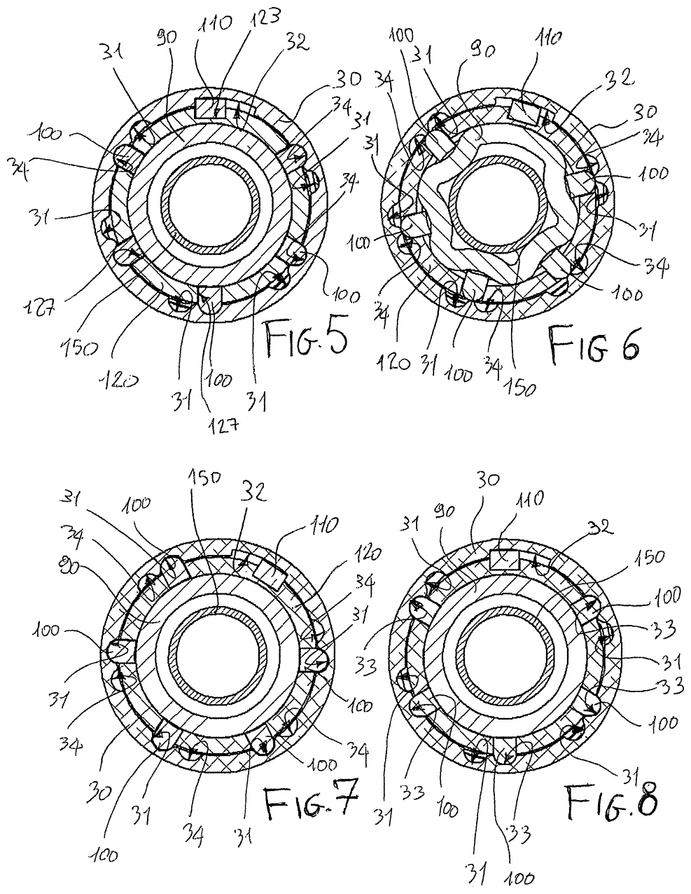

In FIG. 6, quill 120 has been twisted about halfway between the upper locked position and an unlocked position.

In this configuration, spring 90 is elastically bent as lock elements 100 have been forced inward, as they contact the filleted areas between partial upper slots 34 and first through slots 31.

As this configuration is reached, it is very easy to either rotate the quill 120 into the unlocked position, shown in FIGS. 7,10, or to rotate it back into the locked position shown in FIGS. 5,9.

In this configuration, key 110 is in the middle of second through slot 32.

When quill 120 is in the unlocked position (shown in FIGS. 7,10), it is held up by spring cartridge 150: by sitting on saddle 140, the rider will overcome the force of spring cartridge 150, and he will lower quill 120 and saddle 140 until the position shown in FIG. 11 is reached.

When quill 120 is in the unlocked position, lock elements 100 tightly fit the respective first through slots 31: as the rider sits on saddle 140, lock elements 100 slide longitudinally along first through slots 31, from top downwards.

As quill 120 reaches the position shown in FIG. 11, the rider can twist the saddle 140 back, to reach the lower locked position shown in FIGS. 8,12; if the rider unweights the saddle 140 without twisting it back, the latter will rise back as shown in FIG. 10.

In the lower locked position (FIG. 8), lock elements 100 tightly fit partial lower slots 33, and key 110 rests back against the side of the second through slot 32; lock elements 100 also abut on respective top surfaces 36, and upward movement of quill 120 relative to body 30 is prevented.

Twisting the saddle 140 can be done either by sitting on it and the rider twisting his bottom, or by the rider using his legs.

For example, to twist saddle 140 from the upper locked position to the upper unlocked position, the rider can stand and put his left leg on the side of the nose of saddle 140, and push to the right.

Sitting on saddle 140 will drop the latter into the lower unlocked position; pushing the right side of the nose of saddle 140 will lock the seat post in the lower locked position.

To raise the saddle 140, the rider can either “sit and twist” or stand and push the nose of saddle 140 to the right, and the saddle will immediately raise to the upper unlocked position.

With a small amount of practice, raising and lowering the saddle 140 becomes fast and easy.

FIGS. 19-21 show the upper locked position of seat post 10 in greater detail.

In this position, second side surfaces 102 of lock elements 100 contact (i.e., rest on) respective bottom surfaces 35 of partial upper slots 34.

Additionally, first side surfaces 101 of lock elements 100 contact base 41 of spacer 40, preventing upward movement of lock elements 100, and therefore of quill 120, relative to body 30.

Furthermore, upper end surface 111 of key 110 contacts base 41 of spacer 40, also preventing upward movement of quill 120 relative to body 30.

All lock elements 100 function simultaneously and in the same way.

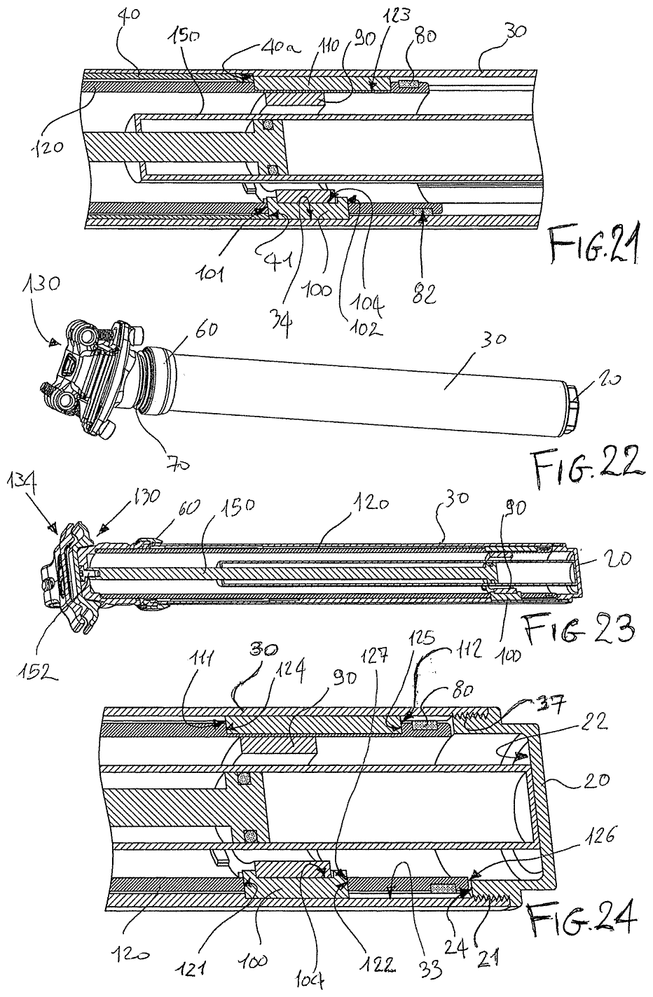

FIGS. 22-24 show the lower locked position of seat post 10 in greater detail.

As shown in FIG. 24, first side surfaces 101 of lock elements 100 contact respective top surfaces 36 of partial lower slots 33, preventing upward movement of lock elements 100, and therefore of upward movement of quill 120 relative to body 30.

In this lower locked position, second side surfaces 102 of lock elements 100 are not directly prevented from moving downward relative to body 30.

Instead, downward movement of quill 120 is prevented by contact of lower base surface 126 on top surface 24 of end cap 20.

The embodiment of seat post 10 shown in the attached figures requires (looking down on saddle 140) twisting clockwise to unlock and counter-clockwise to lock.

In alternative embodiments, not shown in the figures, the actuation of the seat post 10 could be designed to allow the rider to unlock by twisting in either direction.

This could be done by adding more first through slots 31 in body 30, and by widening second through slot 32 to allow a wider rotation of quill 120 within body 30.

In a simplified embodiment of the invention, quill 120 may comprise a single lock element 100, of appropriate size, slideably engaged in a respective single through seat 127; correspondingly, body 30 may comprise a single first through slot 31, a single partial upper slot 34 and a single partial lower slot 33. In this case, lock element 100 should be designed to support rider's weight as quill 120 is in the upper locked position.

In the description above, whenever terms like “upper” or “lower” are used, they refer only to the position that the seat post 10 assumes in use, and they are conventionally used to identify and distinguish the various parts of the device, without any limiting effect.

In the embodiments disclosed hereafter individual features, given in connection with such specific embodiments, may actually be interchanged with other different features that exist in other embodiments.

The present invention has been described according to preferred embodiments, but equivalent variants can be devised without departing from the scope of protection offered by the following claims.

What is claimed is:

1. A height adjustable seat post comprising:
a body, suitable to be inserted into a seat tube of a bicycle frame,
a quill, comprising a head assembly with clamping means suitable to attach to a bicycle saddle,
said quill being slideably associated to said body to be selectively translated between at least an upper locked position and a lower locked position, respectively corresponding to at least an upper height position and a lower height position of the saddle,
wherein said quill includes at least a spring, inserted into its inner cavity, and a plurality of lock elements, slideably engaged in a respective plurality of through seats, distributed along quill cross section, wherein said spring is suitable to spring load said lock elements radially outward so as to protrude from said respective through seats,
wherein said body comprises, on its inner surface, a plurality of first through slots, a plurality of partial upper slots and a plurality of partial lower slot, distributed along body cross section,
wherein said first through slots, said partial upper slots and partial lower slots are in the same number of said lock elements, and
wherein said lock elements are selectively engageable, by rotation of said quill within said body performed by the rider, in said partial upper slots so as to retain said quill in said upper locked position, or in said partial lower slots so as to retain said quill in said lower locked position, or in said first through slots, along which they can slide, so as to allow the rider to translate said quill between said upper height position and said lower height position of the saddle.

2. The seat post according to claim 1, wherein said lock elements have a planar, or substantially planar, inner surface, and a rounded, or substantially rounded, outer surface.

3. The seat post according to claim 2, wherein said spring is ring shaped, or substantially ring shaped, and it has an outer surface contacting the inner surface of said lock elements.

4. The seat post according to claim 3, wherein said spring is made of an elastomer or any other suitable material, or it is made from a spring steel continuous or non-continuous band.

5. The seat post according to claim 3, wherein said lock element includes, by its inner surface, a respective recess suitable for housing the outer portion of said spring.

6. The seat post according to claim 1, including at least a spring cartridge, inserted in said body housing, passing through said quill and connected to said head assembly, wherein said spring cartridge acts on said head assembly in order to push said quill out of said body housing.

7. The seat post according to claim 6, wherein said spring cartridge includes a gas pressurized piston with damping, or a compression coil spring or any other suitable compression spring.

8. The seat post according to claim 1, wherein said quill includes at least a key, fitting into a key slot provided in its outer surface, and wherein said body includes, on its inner surface, a second through slot, in which said key is engaged, and along which said key can longitudinally slide.

9. The seat post according to claim 8, wherein, when said body is observed in cross section, said second through slot is larger than said key, so that said quill can rotate, within said body, a limited amount.

10. The seat post according to claim 1, wherein said partial lower slots are distributed, within the inner surface of said body, at the same angular distances provided for between said lock elements in said quill, and wherein said partial lower slots are offset, by a certain angle, relative to said first through slots.

11. The seat post according to claim 10, wherein said partial upper slots are distributed, within the inner surface of said body, at the same angular distances provided for between said lock elements in said quill, and wherein said partial upper slots are offset by a certain angle, relative to said first through slots.

12. The seat post according to claim 11, wherein said partial upper slot and said partial lower slot are superimposed when said body is observed in cross section.

13. The seat post according to claim 1, wherein said first through slots, said partial upper slots and said partial lower slots have rounded, or substantially rounded cross section, complementary to the cross section of said lock elements.

14. The seat post according to claim 13, wherein the inner surface of said body includes, at the portions included between said first through slots and said partial upper slots, and/or between said first through slots and said partial lower slots, filleted areas which are suitable to facilitate the passage of said lock elements between different slots, as said quill rotates within said body.

15. The seat according to claim 16, wherein, when said body is observed in cross section, said partial upper slots are superimposed to said partial lower slots.

16. The seat post according to claim 1, wherein said partial upper slots have respective bottom surfaces onto which said lock elements abut as said quill is in the upper locked position, and downward movement of said quill relative to said body is prevented.

17. The seat post according to claim 1, wherein said partial lower slots have respective top surfaces onto which said lock elements abut as said quill is in the lower locked position, and upward movement of said quill relative to said body is prevented.

18. The seat post according to claim 1, including a spacer having a base which abuts on a shoulder provided in the inner surface of said body, wherein each of said lock elements include a respective first side surface which contacts said base as said quill is in said upper locked position, preventing upward movement of said quill relative to said body.

19. A height adjustable seat post comprising:
a body suitable to be inserted into a seat tube of a bicycle frame,
a quill comprising a head assembly with clamping means suitable to attach to a bicycle saddle,
said quill being slideably associated to said body to be selectively translated between at least an upper locked position and a lower locked position, respectively corresponding to at least an upper height position and a lower height position of the saddle,
wherein said quill includes at least a spring, inserted into its inner cavity, and a lock element, slideably engaged in a respective through seat provided in said quill,
wherein said spring is suitable to spring load said lock element radially outward so as to protrude from said through seat,
wherein said body comprises, on its inner surface, a first through slot, a partial upper slot and a partial lower slot,
wherein said lock element is selectively engageable, by rotation of said quill within said body, performed by the rider, in said partial upper slot so as to retain said quill in said upper locked position, or in said partial lower slot so as to retain said quill in said lower locked position, or in said first through slot, along which it can slide, so as to allow the rider to translate said quill between said upper height position and said lower height position of the saddle.

20. The seat post according to claim 19, including at least a spring cartridge, inserted in said body housing, passing through said quill and connected to said head assembly, wherein said spring cartridge constantly acts on said head assembly in order to push said quill out of said body housing.

21. The seat post according to claim 19, wherein said quill includes at least a key, fitting into a key slot provided in its outer surface, and wherein said body includes, on its inner surface, a second through slot, in which said key is engaged, and along which said key can longitudinally slide.

22. The seat post according to claim 21, wherein, when said body is observed in cross section, said second through slot is larger than said key, so that said quill can rotate, within said body, a limited amount.
